(19) United States
(12) Patent Application Publication
(10) Pub. No.: US 2026/0058124 A1
(43) Pub. Date: Feb. 26, 2026

(54) ELECTRODE ASSEMBLY AND RECHARGEABLE BATTERY WITH THE SAME

(71) Applicant: SAMSUNG SDI CO., LTD., Yongin-si (KR)

(72) Inventor: Hyunggi KIM, Yongin-si (KR)

(73) Assignee: SAMSUNG SDI CO., LTD., Yongin-si (KR)

(21) Appl. No.: 19/223,933

(22) Filed: May 30, 2025

(30) Foreign Application Priority Data
Aug. 21, 2024 (KR) 10-2024-0112288

(51) Int. Cl. H01M 4/36; H01M 4/02; H01M 4/38; H01M 4/583; H01M 50/103; H01M 50/119

(52) U.S. Cl. CPC H01M 4/362; H01M 4/386; H01M 4/583; H01M 50/103; H01M 50/119; H01M 2004/027

(57) ABSTRACT

An electrode assembly includes a plurality of positive electrodes and a plurality of negative electrodes alternately stacked. The plurality of negative electrodes include a plurality of first negative electrodes and at least one second negative electrode located outside of the plurality of first negative electrodes. At least one of the plurality of first negative electrodes includes a first substrate and first active material layers on both surfaces of the first substrate. The second negative electrode includes a second substrate and a second active material layer on one surface of the second substrate. A content of a silicon-based active material in the second active material layer is higher than a content of a silicon-based active material in the first active material layer.

### CROSS-REFERENCE TO RELATED APPLICATION

This application claims the benefit of priority to Korean Patent Application No. 10-2024-0112288, filed in the Korean Intellectual Property Office on Aug. 21, 2024, the entire contents of which are incorporated herein by reference.

### BACKGROUND OF THE DISCLOSURE

### (a) Field of the Disclosure

Examples of the present disclosure relate to a rechargeable battery, to a stacked electrode assembly, and to a rechargeable battery including the stacked electrode assembly.

### (b) Description of the Related Art

A rechargeable battery typically includes an electrode assembly for charging or discharging current, a case for accommodating and sealing the electrode assembly and an electrolytic solution in an internal space, and electrode terminals connected to the electrode assembly. The electrode assembly may be or include a wound type in which electrodes and separators are wound in the form of a jelly roll, or a stacked type in which a plurality of electrodes are stacked with separators therebetween.

In general, an electrode includes a substrate and active material layers located on both surfaces of the substrate. An active material layer located on an outer surface of a substrate in the outermost electrode of the stacked electrode assembly does not contribute to battery reactions. Therefore, in order to maximize the capacity within a limited size and thickness, the active material layer of the outermost electrode may be only located on an inner surface of the substrate.

The stacked electrode assembly may be manufactured by cutting a plurality of electrodes into a desired size, aligning the plurality of electrodes together with a separator, and stacking the electrodes. However, for the electrode having an active material layer disposed on only one surface, a curling phenomenon may occur in which the electrode bends due to a difference in elongation rate between the substrate and the active material layer during a process of manufacturing the electrode. Electrodes that undergo curling are challenging to transport and align.

### SUMMARY OF THE DISCLOSURE

Examples of the present disclosure include an electrode assembly capable of reducing or suppressing a curling phenomenon of an electrode having an active material layer disposed on one surface of a substrate, and a rechargeable battery including the electrode assembly.

An electrode assembly according to an example embodiment includes a plurality of positive electrodes and a plurality of negative electrodes, alternately stacked with a separator interposed between each positive electrode and negative electrode pair. The plurality of negative electrodes include a plurality of first negative electrodes and at least one second negative electrode outside of the plurality of first negative electrodes. Each, or at least one, of the plurality of first negative electrodes includes a first substrate, and first active material layers on both surfaces of the first substrate. The second negative electrode includes a second substrate and a second active material layer located on one surface of the second substrate. A content of a silicon-based active material in the second active material layer is higher than a content of a silicon-based active material in the first active material layer.

The second negative electrode may be provided as a pair of second negative electrodes, and the pair of second negative electrodes may be located on both outermost sides of the electrode assembly. The second active material layer may be located on an inner surface of the second substrate.

The first active material layer may include about 100 wt % of a carbon-based active material. The second active material layer may include a carbon-based active material and the silicon-based active material, and the content of the silicon-based active material in the second active material layer may be equal to about 50 wt % or more.

In an example, the first active material layer may include about 100 wt % of a carbon-based active material, and the second active material layer may include about 100 wt % of the silicon-based active material. For example, each, or at least one, of the first active material layer and the second active material layer may include a carbon-based active material and the silicon-based active material. The content of the silicon-based active material in the first active material layer may be less than about 50 wt %, and the content of the silicon-based active material in the second active material layer may be equal to about 50 wt % or more.

A thickness of the second active material layer may be equal to or less than a thickness of the first active material layer. A thickness of the second substrate may be equal to or less than a thickness of the first substrate.

An electrode assembly according to another example embodiment includes a plurality of positive electrodes, a plurality of first negative electrodes, and at least one second negative electrode. The plurality of first negative electrodes are located between two adjacent positive electrodes among the plurality of positive electrodes, and each, or at least one, of the plurality of first negative electrodes includes a first substrate and first active material layers located on both surfaces of the first substrate. The second negative electrode is located on an outer side of an outermost positive electrode among the plurality of positive electrodes, and includes a second substrate and a second active material layer on an inner surface of the second substrate. The first active material layer includes a carbon-based active material, and the second active material layer includes about 50 wt % or more of a silicon-based active material.

The second negative electrode may be a pair of second negative electrodes, and the pair of second negative electrodes may be located on both outermost sides of the electrode assembly. The first active material layer may include about 100 wt % of a carbon-based active material.

On the other hand, the first active material layer may include the carbon-based active material and a silicon-based active material, and a content of the silicon-based active material in the first active material layer may be less than about 50 wt %. The second active material layer may include a carbon-based active material and the silicon-based active material. On the other hand, the second active material layer may include about 100 wt % of the silicon-based active material.

A thickness of the second active material layer may be equal to or less than a thickness of the first active material layer. A thickness of the second substrate may be equal to or less than a thickness of the first substrate.

A rechargeable battery according to an example embodiment includes an electrode assembly, a can made of or including a metal material, and a cap plate. The electrode assembly is configured with a plurality of positive electrodes and a plurality of negative electrodes, alternately stacked, with a separator interposed between each positive electrode and negative electrode pair. The can may have a concave interior space configured to accommodate the electrode assembly, and may be open on one side. The cap plate is joined to the can to seal the can. The plurality of negative electrodes include a plurality of first negative electrodes inside the electrode assembly, and at least one second negative electrode on an outermost side of the electrode assembly. Each, or at least one, of the plurality of first negative electrodes includes a first substrate and first active material layers positioned on both surfaces of the first substrate. The second negative electrode includes a second substrate and a second active material layer on an inner surface of the second substrate. A content of a silicon-based active material in the second active material layer is higher than a content of a silicon-based active material in the first active material layer.

The can may be made of or include stainless steel. A content of the silicon-based active material in the second active material layer may be about 50 wt % or more. A thickness of the second active material layer may be equal to or less than a thickness of the first active material layer, and a thickness of the second substrate may be equal to or less than a thickness of the first substrate.

The electrode assembly of an example embodiment can effectively reduce or suppress curling of the second negative electrode substantially without capacity reduction. A second negative electrode that is substantially flat and that does not exhibit curling is easier to transport and to align during a manufacturing process of the electrode assembly. In addition, the rechargeable battery of the present example embodiment can effectively reduce or suppress volume expansion of the second active material layer by using the high-strength can.

### BRIEF DESCRIPTION OF THE DRAWINGS

FIG. 1 is a perspective view of an electrode assembly according to an example embodiment.

FIG. 2 is an exploded perspective view of the electrode assembly illustrated in FIG. 1.

FIG. 3 is a partially enlarged cross-sectional view of the electrode assembly illustrated in FIG. 1.

FIGS. 4A to 4D are photographs of second negative electrodes according to Comparative Examples 1 to 4.

FIG. 5 is a photograph of a second negative electrode according to Example 1.

FIG. 6 is a perspective view of a rechargeable battery according to an example embodiment.

FIG. 7 is a cross-sectional view of the rechargeable battery taken along line VII-VII of FIG. 6.

### DETAILED DESCRIPTION

In the following detailed description, only certain example embodiments of the present disclosure have been shown and described, simply by way of illustration. The present disclosure can be variously implemented and is not limited to the following example embodiments.

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

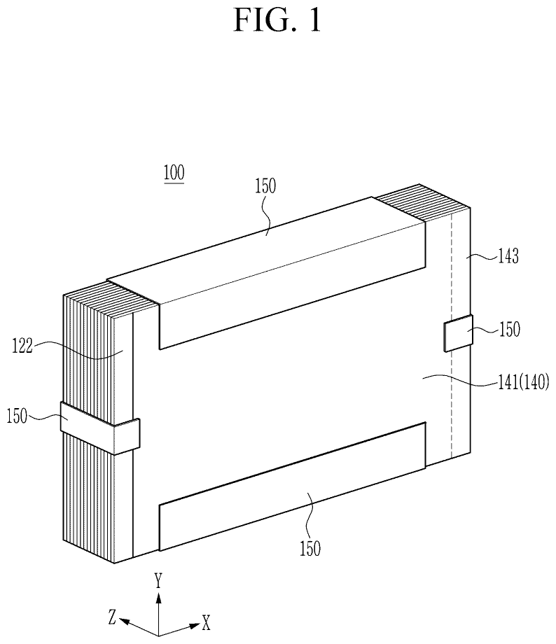

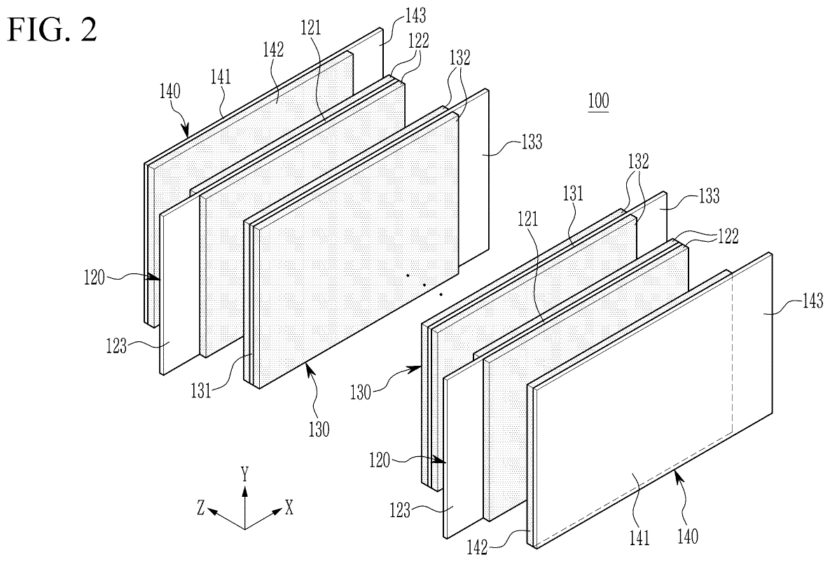

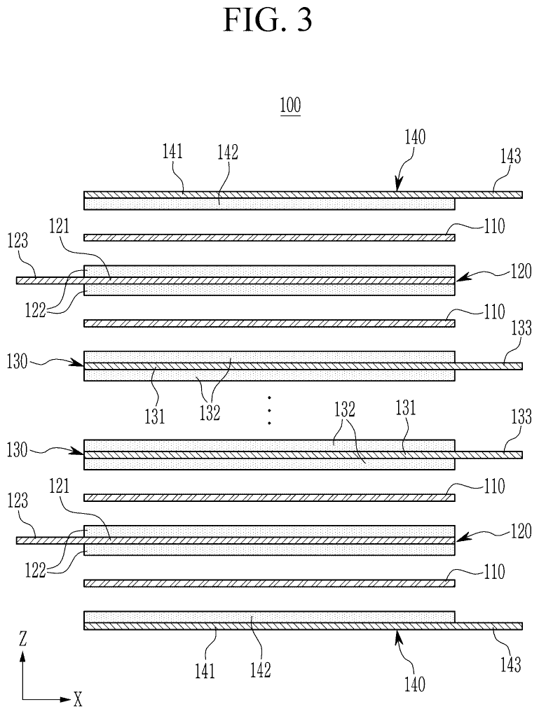

FIG. 1 is a perspective view of an electrode assembly according to an example embodiment. FIG. 2 is an exploded perspective view of the electrode assembly shown in FIG. 1, and FIG. 3 is a partially enlarged cross-sectional view of the electrode assembly shown in FIG. 1. In FIG. 2, a separator is not shown for convenience.

Referring to FIGS. 1 to 3, an electrode assembly 100 of the present example embodiment is a stacked type electrode assembly, and may include a plurality of positive electrodes 120 and a plurality of negative electrodes 130 and 140, alternately stacked, with a separator 110 interposed between each positive electrode and negative electrode pair. Each, or at least one, of the plurality of separators 110, the plurality of positive electrodes 120, and the plurality of negative electrodes 130 and 140 may have a thin quadrangular sheet shape.

The plurality of negative electrodes 130 and 140 may include a plurality of first negative electrodes 130 and at least one second negative electrode 140. The plurality of first negative electrodes 130 may be located on an inner side of the electrode assembly 100, and at least one second negative electrode 140 may be located on an outermost side of the electrode assembly 100. For example, two second negative electrodes 140 may be located on both outermost sides of the electrode assembly 100.

Each, or at least one, of the plurality of first negative electrodes 130 may be located between two adjacent positive electrodes 120, and may face the positive electrodes 120 on both surfaces. On the other hand, the second negative electrode 140 may face the positive electrode 120 only on one surface (inner surface). The outermost positive electrode 120 among the plurality of positive electrodes 120 may face the second negative electrode 140.

Each, or at least one, of the plurality of positive electrodes 120 may include a positive substrate 121 and a pair of positive active material layers 122 located on both surfaces of the positive substrate 121. The positive electrode 120 may be referred to herein as a full cathode.

The positive substrate 121 may be composed of, or include, a thin metal sheet with desired or improved electrical conductivity, such as, e.g., an aluminum foil or an aluminum mesh. The positive active material layer 122 includes a positive active material, and may optionally further include a binder and/or a conductive material. The positive substrate 121 is configured to provide a path for migration of charges generated in the positive active material layer 122, and supports the positive active material layer 122.

The positive active material may include a lithium transition metal composite oxide. The lithium transition metal composite oxide may include, for example, at least one of a lithium-nickel-based oxide, a lithium-cobalt-based oxide, a lithium-manganese-based oxide, a lithium-iron phosphate-based compound, and a cobalt-free lithium nickel-manganese-based oxide.

Each, or at least one, of the plurality of first negative electrodes 130 may include a first negative substrate (first substrate) 131 and a pair of first negative active material layers (first active material layers) 132 located on both surfaces of the first negative substrate 131. The first negative electrode 130 may be referred to herein as a full anode. The second negative electrode 140 may include a second negative substrate (second substrate) 141 and a second negative active material layer (second active material layer) 142 located on one surface (inner surface) of the second negative substrate 141. The second negative electrode 140 may be referred to herein as a half anode.

Assuming that the second active material layer is located on an outer surface of the second substrate, the second active material layer may not contribute to battery reactions because there is no positive active material layer facing the second active material layer. The electrode assembly 100 should increase or maximize the capacity within a given size and thickness. To increase the capacity, the second negative electrode 140 may have the second active material layer 142 only on the inner surface facing the positive electrode 120.

The first substrate 131 and the second substrate 141 may be composed of, or include, a thin metal sheet with desired or improved electrical conductivity, such as, e.g., a copper foil, a copper mesh, a nickel foil, or a nickel mesh. The first active material layer 132 and the second active material layer 142 may include a negative active material, and may optionally further include a binder and/or a conductive material.

The first substrate 131 is configured to provide a path for migration of charges generated in the first active material layer 132 and supports the first active material layer 132. The second substrate 141 is configured to provide a path for migration of charges generated in the second active material layer 142 and supports the second active material layer 142.

The negative active material may include at least one of a carbon-based active material and a silicon-based active material. The carbon-based active material may include at least one of natural graphite and artificial graphite. The silicon-based active material may include at least one of a silicon-carbon composite active material, a silicon oxide (SiOₓ, 0<x≤2), and silicon carbide (SiC).

In each, or at least one, of the positive active material layer 122 and the first and second active material layers 132 and 142, the binder may include at least one of an aqueous binder, a non-aqueous binder, and a dry binder. In each, or at least one, of the positive active material layer 122 and the first and second negative active material layers 132 and 142, the conductive material may include at least one of a carbon-based material such as natural graphite, artificial graphite, carbon black, carbon fiber, carbon nanofiber, and carbon nanotube; a metal material in the form of metal powder or metal fiber including copper, nickel, aluminum, or silver; and a conductive polymer such as a polyphenylene derivative.

The separator 110 may be composed of, or include, a porous base material or a porous base material having a coating layer positioned on at least one surface. The porous base material may include one or more of polyethylene, polypropylene, polyethylene terephthalate, polypropylene terephthalate, polybutylene terephthalate, polyester, polycarbonate, and polyimide. The coating layer may include a binder, and the binder may include a polyvinylidene fluoride-based compound. The separator 110 can insulate the positive electrode 120 and the negative electrode 130 and 140 while allowing migration of lithium ions.

In each, or at least one, of the plurality of positive electrodes 120, the positive active material layer 122 may be located on the remaining portion of the positive substrate 121 except for an edge on one side (for example, the left side of the drawing). A portion of the positive substrate 121, which is not covered with the positive active material layer 122, may be referred to as a positive uncoated portion 123. A plurality of positive uncoated portions 123 stacked on each other may be integrally fixed by, e.g., welding or the like.

In each, or at least one, of the plurality of negative electrodes 130 and 140, the negative active material layer 132, 142 may be located on the remaining portion of the negative substrate 131, 141 except for an edge on the other side (for example, the right side of the drawing). A portion of the negative substrate 131, 141, which is not covered with the negative active material layer 132, 142, may be referred to as a negative uncoated portion 133, 143. A plurality of negative uncoated portions 133 and 143 stacked on each other may be integrally fixed by, e.g., welding or the like.

The second substrate 141 may be positioned on the outermost side of the electrode assembly 100, and the electrode assembly 100 may maintain a stacked form without disorder by at least one insulating tape 150. For example, the insulating tape 150 may be attached to a portion of a front surface, a portion of a side surface, and a portion of a rear surface of the electrode assembly 100, and a plurality of insulating tapes 150 such as, e.g., four insulating tapes 150, may be attached, one at each of four corners of the electrode assembly 100.

Each, or at least one, of the plurality of first negative electrodes 130 may be manufactured by applying a first active material slurry to both surfaces of a first substrate, drying and compressing the applied first active material slurry, and slitting (cutting) the first substrate.

Since a pair of first active material layers 132 having substantially the same composition, the same density, and the same thickness are positioned on both surfaces of the first substrate 131, the plurality of first negative electrodes 130 do not bend (curl) after slitting. The plurality of positive electrodes 120 also do not bend (curl) after slitting for the same reason as the plurality of first negative electrodes 130.

The second negative electrode 140 may be manufactured by applying a second active material slurry to one surface of a second substrate, drying and compressing the applied second active material slurry, and slitting the second substrate.

In general, the second negative electrode may bend (curl) toward the second substrate after slitting due to a difference in elongation rate between the second substrate and the second active material layer during the compression process. A bent (curling) second negative electrode may cause difficulties in conveying and alignment, which may reduce the manufacturing yield of the electrode assembly.

In order to reduce the difference in elongation rate between the second substrate and the second active material layer, a method may be considered in which a thick metal material with a thickness of about 20 μm to 25 μm is used for the second substrate and a thickness of the second active material layer is reduced. For example, the thickness of the second substrate may be greater than the thickness of the first substrate, and the thickness of the second active material layer may be smaller than the thickness of the first active material layer. This method has the effect of reducing or suppressing the bending (curling) of the second negative electrode, but the capacity of the electrode assembly decreases due to the increased thickness of the second substrate and the reduced thickness of the second active material layer.

In the electrode assembly 100 of the present example embodiment, the second substrate 141 may be manufactured from the same material as the first substrate 131, and a thickness of the second substrate 141 may be equal to or slightly greater than a thickness of the first substrate 131. For example, the thickness of the first substrate 131 may be approximately 5 μm to 8 μm, and the thickness of the second substrate 141 may be approximately 6 μm to 15 μm.

Additionally, in the electrode assembly 100 of the present example embodiment, the second active material layer 142 may have an active material composition that is different from the active material composition of the first active material layer 132. For example, a content of the silicon-based active material in the second active material layer 142 may be greater than a content of the silicon-based active material in the first active material layer 132.

For example, the first active material layer 132 may include less than about 50 wt % of the silicon-based active material, and the second active material layer 142 may include about 50 wt % or more of the silicon-based active material. In addition, a thickness of the second active material layer 142 may be equal to or smaller than a thickness of the first active material layer 132.

For example, the first active material layer 132 may include about 100 wt % of the carbon-based active material, and the second active material layer 142 may include about 100 wt % of the silicon-based active material, or may include both the carbon-based active material and the silicon-based active material, with about 50 wt % or more of the silicon-based active material.

As another example, each, or at least one, of the first active material layer 132 and the second active material layer 142 may include a carbon-based active material and a silicon-based active material. In this case, a content of the silicon-based active material in the first active material layer 132 may be less than about 50 wt %, and a content of the silicon-based active material in the second active material layer 142 may be equal to or more than about 50 wt %.

As described above, the silicon-based active material may include at least one of a silicon-carbon composite active material, a silicon oxide (SiOₓ, 0<x≤2), and silicon carbide (SiC). The silicon-carbon composite active material may include at least one of a first composite active material, a second composite active material, and a third composite active material.

The first composite active material may include a plurality of silicon nanoparticles and an amorphous carbon coating layer located on surfaces of the silicon nanoparticles. The second composite active material may include a core including a silicon-carbon composite, and a polymer coating layer positioned on a surface of the core. The third composite active material may include a core including a silicon-based material, and a carbon-based coating layer on a surface of the core.

In general, the capacity of silicon-based active materials is higher than the capacity of carbon-based active materials. For example, the capacity of graphite is approximately 356 mAh/g, and the capacity of silicon is approximately 1,841 mAh/g. Additionally, the density of the negative active material layer including a silicon-based active material is generally lower than the density of the negative active material layer including a carbon-based active material.

A thickness of the first active material layer 132 may be in a range of approximately 100 μm to 120 μm, and a thickness of the second active material layer 142 may be in a range of approximately 30 μm to 65 μm. The second active material layer 142 can reduce the difference in elongation rate with the second substrate 141 due to the small thickness and low density of the second active material layer 142, and as a result, can reduce or suppress bending (curling) of the second negative electrode 140. In addition, since the silicon-based active material has a higher capacity than the carbon-based active material, the second active material layer 142 can implement sufficient capacity even with a small thickness.

When the content of the silicon-based active material in the second active material layer 142 is less than about 50 wt %, it becomes difficult to achieve the aforementioned effects (effects due to small thickness, low density, and high capacity) resulting from the use of the silicon-based active material. Therefore, the second active material layer 142 may include 50 about wt % or more of the silicon-based active material.

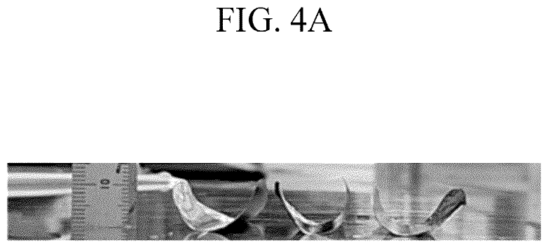

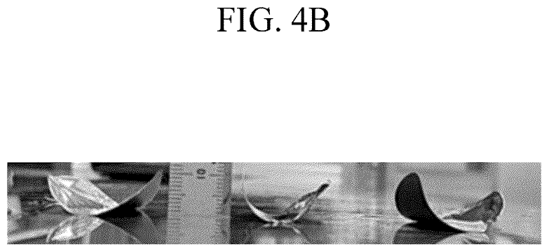

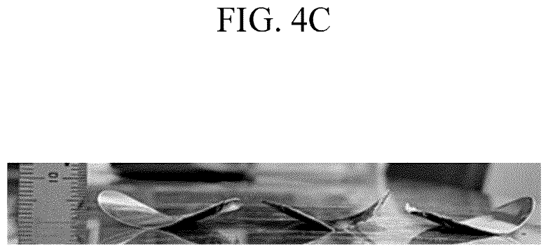

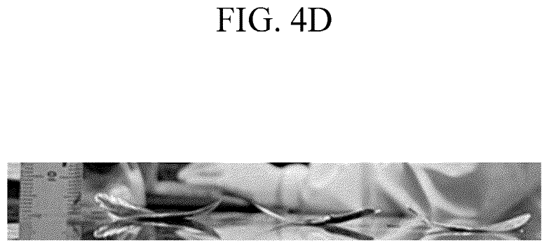

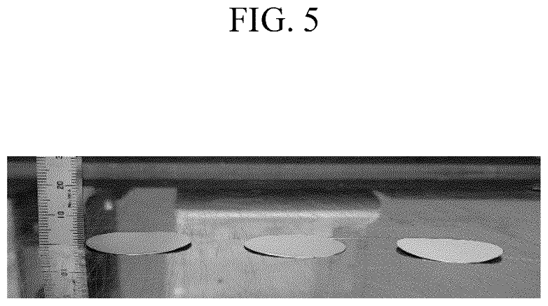

FIGS. 4A to 4D are photographs of second negative electrodes according to Comparative Examples 1 to 4. Three second negative electrodes are shown in each of FIGS. 4A to 4D. FIG. 5 is a photograph of a second negative electrode according to Example 1. Table 1 below shows the characteristics of the second negative electrodes according to Comparative Examples 1 to 4 and Example 1.

TABLE 1

| | | Comparative | Comparative | Comparative | Comparative | Example |
|---|---|---|---|---|---|---|
| | | Example 1 | Example 2 | Example 3 | Example 4 | 1 |
| Second | Material | copper | copper | copper | copper | copper |
| substrate | Thickness | 12 | 12 | 20 | 20 | 6 |
| | (μm) | | | | | |
| Second | Material | carbon- | carbon- | carbon- | carbon- | silicon- |
| active | | based 100% | based 100% | based 100% | based 100% | based |
| material | | | | | | 100% |
| layer | Density | 1.55 | 1.45 | 1.67 | 1.45 | 0.32 |
| | (g/cc) | | | | | |
| | Thickness | 71 | 75 | 74 | 79 | 63 |
| | (μm) | | | | | |

| | | | | | |
|---|---|---|---|---|---|
| Average bending | 12.67 | 11.33 | 6.17 | 5.5 | 1.5 |
| (curling) height of | | | | | |
| three second | | | | | |
| negative electrodes | | | | | |
| (mm) | | | | | |

In Comparative Examples 1 to 4, the second active material layers include a negative active material of 100 wt % of graphite and has a thickness in a range of 70 μm to 80 μm. In Comparative Examples 1 and 2, the second substrate has a thickness of 12 μm, and in Comparative Examples 3 and 4, the second substrate has a thickness of 20 μm.

The average bending (curling) heights of the second negative electrodes in Comparative Examples 3 and 4, where the thicknesses of the second substrates are greater than the thicknesses of the substrates of Comparative Examples 1 and 2, are smaller than the average bending (curling) heights of the second negative electrodes of Comparative Examples 1 and 2. However, because the second substrate is a part that does not contribute to the battery reactions, the second negative electrodes of Comparative Examples 3 and 4 cause a decrease in the capacity of the electrode assembly.

In Example 1, the second substrate has a thickness of about 6 μm. In Example 1, the second active material layer includes 100 wt % of silicon carbide (SiC) as the silicon-based active material, and has a thickness of about 63 μm and a density of about 0.32 g/cc. In Example 1, the thickness of the second substrate is smaller than the thicknesses of the second substrates of Comparative Examples 1 to 4. In Example 1, the thickness and density of the second active material layer are smaller than the thicknesses and densities of the second active material layers of Comparative Examples 1 to 4, respectively.

The second negative electrode of Example 1 can reduce the difference in elongation rate with the second substrate due to the changed composition and reduced density and thickness of the second active material layer. As a result, the second negative electrode of Example 1 exhibits a lower bending (curling) height than the bending (curling) heights of the second negative electrodes of Comparative Examples 1 to 4.

In addition, since the second negative electrode of Example 1 uses the silicon-based active material, even when the thickness of the second active material layer is smaller than the thicknesses of the second active material layers of Comparative Examples 1 to 4, the second active material layer of Example 1 can achieve a higher capacity than the capacities of the second active material layers of Comparative Examples 1 to 4. Additionally, the reduced thickness of the second substrate can lead to an increase in the capacity of the electrode assembly.

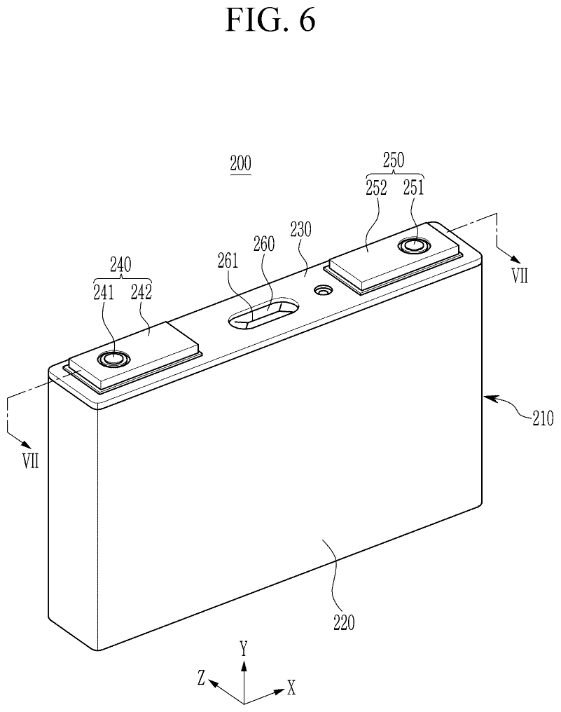

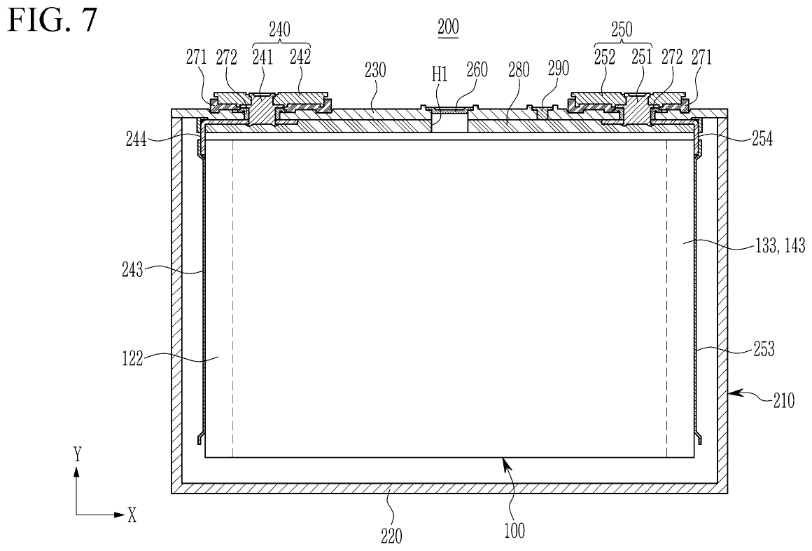

Accordingly, the electrode assembly 100 of the present example embodiment can effectively reduce or suppress bending (curling) of the second negative electrode 140 substantially without reducing the capacity thereof. The second negative electrode 140, which is substantially flat and without bending (curling), is easier to transport and align during the manufacturing process of the electrode assembly 100, thereby improving the manufacturing yield of the electrode assembly 100. FIG. 6 is a perspective view of a rechargeable battery according to an example embodiment. FIG. 7 is a cross-sectional view of the rechargeable battery taken along line VII-VII of FIG. 6.

Referring to FIGS. 6 and 7, a rechargeable battery 200 of the present example embodiment may include the electrode assembly 100 configured as described above, and a case 210 that accommodates and seals the electrode assembly 100 and an electrolyte in an internal space. The electrolyte may be in one of liquid, solid, or gel forms. The case 210 may have a generally rectangular parallelepiped shape, and the rechargeable battery 200 of the present example embodiment may be a prismatic rechargeable battery.

The case 210 may include a can 220 with a concave internal space, one side of which is open, and a cap plate 230 coupled to the can 220 to seal the can 220. The can 220 may be made of or include high-strength metal such as stainless steel, and an inner surface of the can 220 may be insulated. A positive terminal 240, a negative terminal 250, and a safety vent 260 may be provided on the cap plate 230.

The positive terminal 240 may include a first pillar 241 and a first terminal plate 242, and may be electrically connected to the plurality of positive electrodes 120 (see FIGS. 2 and 3) through a first current collector 243 and a first terminal connection portion 244. The first current collector 243 may be joined to the positive uncoated portions 123 (see FIGS. 2 and 3) by a method such as, e.g., welding.

The negative terminal 250 may include a second pillar 251 and a second terminal plate 252, and may be electrically connected to the plurality of negative electrodes 130 and 140 (see FIGS. 2 and 3) through a second current collector 253 and a second terminal connection portion 254. The second current collector 253 may be joined to the negative uncoated portions 133 and 143 (see FIGS. 2 and 3) by a method such as welding.

Each, or at least one, of the positive terminal 240 and the negative terminal 250 can be insulated from the cap plate 230 by an upper insulator 271, a seal gasket 272, and a lower insulator 280. The seal gasket 272 can hinder or substantially prevent external moisture from penetrating into the case 210 and the electrolyte inside the case 210 from leaking to the outside.

A vent hole H1 may be provided in the cap plate 230 and the lower insulator 280, and the safety vent 260 may be installed in the vent hole H1 of the cap plate 230. The safety vent 260 is a metal plate having a thickness that is smaller than the thickness of the cap plate 230, and may be provided with a notch 261 that breaks at a set pressure to relieve an internal pressure. A plug 290 may seal an electrolytic solution injection port provided in the cap plate 230. Referring to FIGS. 1 to 3, 6, and 7, at least one second negative electrode 140 is positioned on the outermost side of the electrode assembly 100. For example, two second negative electrodes 140 may be positioned on both outermost sides of the electrode assembly 100. The second active material layer 142 positioned on the inner surface of the second substrate 141 may include about 50 wt % or more of the silicon-based active material.

In general, negative active materials exhibit volume changes such as expansion during charging, and contraction during discharging, and the volume expansion of silicon-based active materials is greater than the volume expansion of carbon-based active materials. The second active material layer 142 may undergo a larger volume expansion than the first active material layer 132 due to the high content of silicon-based active material. In this case, the can 220 made of high-strength metal, for example, stainless steel, can sufficiently reduce or suppress the volume expansion of the second active material layer 142.

The rechargeable battery 200 of the present example embodiment can increase the manufacturing yield of the electrode assembly 100 by reducing or suppressing bending (curling) of the second negative electrode 140 while increasing or maximizing the capacity of the electrode assembly 100, and can effectively reduce or suppress the volume expansion of the second active material layer 142 by using the high-strength can 220.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

What is claimed is:

1. An electrode assembly comprising:
a plurality of positive electrodes; and
a plurality of negative electrodes alternately stacked, with a separator interposed between each positive electrode and negative electrode pair,
wherein the plurality of negative electrodes comprise a plurality of first negative electrodes and at least one second negative electrode located outside of the plurality of first negative electrodes,
wherein at least one of the plurality of first negative electrodes comprises a first substrate and first active material layers on both surfaces of the first substrate,
wherein the at least one second negative electrode comprises a second substrate and a second active material layer on one surface of the second substrate, and
wherein a content of a silicon-based active material in the second active material layer is higher than a content of a silicon-based active material in the first active material layer.

2. The electrode assembly of claim 1, wherein:
the at least one second negative electrode comprises a pair of second negative electrodes,
wherein the pair of second negative electrodes are located on both outermost sides of the electrode assembly, and
wherein the second active material layer is located on an inner surface of the second substrate.

3. The electrode assembly of claim 1, wherein:
the first active material layer comprises about 100 wt % of a carbon-based active material,
wherein the second active material layer comprises a carbon-based active material and the silicon-based active material, and
wherein the content of the silicon-based active material in the second active material layer is equal to or more than about 50 wt %.

4. The electrode assembly of claim 1, wherein:
the first active material layer comprises about 100 wt % of a carbon-based active material, and
wherein the second active material layer comprises about 100 wt % of the silicon-based active material.

5. The electrode assembly of claim 1, wherein:
each of the first active material layer and the second active material layer comprises a carbon-based active material and the silicon-based active material,
wherein the content of the silicon-based active material in the first active material layer is less than about 50 wt %, and
wherein the content of the silicon-based active material in the second active material layer is equal to or more than about 50 wt %.

6. The electrode assembly of claim 1, wherein:
a thickness of the second active material layer is equal to or less than a thickness of the first active material layer.

7. The electrode assembly of claim 1, wherein:
a thickness of the second substrate is equal to or less than a thickness of the first substrate.

8. An electrode assembly comprising:
a plurality of positive electrodes;
a plurality of first negative electrodes located between two adjacent positive electrodes among the plurality of positive electrodes, and at least one of the plurality of first negative electrodes comprising a first substrate and first active material layers on both surfaces of the first substrate; and
at least one second negative electrode on an outer side of an outermost positive electrode of the plurality of positive electrodes, and comprising a second substrate and a second active material layer on an inner surface of the second substrate,
wherein the first active material layer comprises a carbon-based active material, and the second active material layer comprises about 50 wt % or more of a silicon-based active material.

9. The electrode assembly of claim 8, wherein:
the at least one second negative electrode comprises a pair of second negative electrodes, and
wherein the pair of second negative electrodes is located on both outermost sides of the electrode assembly.

10. The electrode assembly of claim 8, wherein:
the first active material layer comprises about 100 wt % of the carbon-based active material.

11. The electrode assembly of claim 8, wherein:
the first active material layer comprises the carbon-based active material and a silicon-based active material, and
wherein a content of the silicon-based active material in the first active material layer is less than about 50 wt %.

12. The electrode assembly of claim 8, wherein:
the second active material layer comprises a carbon-based active material and the silicon-based active material.

13. The electrode assembly of claim 8, wherein:
the second active material layer comprises about 100 wt % of the silicon-based active material.

14. The electrode assembly of claim 8, wherein:
a thickness of the second active material layer is equal to or less than a thickness of the first active material layer.

15. The electrode assembly of claim 8, wherein:
a thickness of the second substrate is equal to or less than a thickness of the first substrate.

16. A rechargeable battery comprising:
an electrode assembly in which a plurality of positive electrodes and a plurality of negative electrodes are alternately stacked, with a separator interposed between each positive electrode and negative electrode pair;
a can comprising a metal material with a concave interior space configured to accommodate the electrode assembly, one side of the can being open; and
a cap plate joined to the can and configured to seal the can,
wherein the plurality of negative electrodes comprise a plurality of first negative electrodes inside the electrode assembly and at least one second negative electrode on an outermost side of the electrode assembly,
wherein at least one of the plurality of first negative electrodes comprises a first substrate and first active material layers located on both surfaces of the first substrate,
wherein the at least one second negative electrode comprises a second substrate and a second active material layer on an inner surface of the second substrate, and
wherein a content of a silicon-based active material in the second active material layer is higher than a content of a silicon-based active material in the first active material layer.

17. The rechargeable battery of claim 16, wherein:
the can comprises stainless steel.

18. The rechargeable battery of claim 16, wherein:
the content of the silicon-based active material in the second active material layer is about 50 wt % or more.

19. The rechargeable battery of claim 16, wherein:
a thickness of the second active material layer is equal to or less than a thickness of the first active material layer, and
a thickness of the second substrate is equal to or less than a thickness of the first substrate.
